(19) United States
(12) Patent Application Publication
(10) Pub. No.: US 2012/0181332 A1
(43) Pub. Date: Jul. 19, 2012

(54) SYSTEM AND METHOD FOR LOCATING A LOST CHILD'S PARENT/GUARDIAN

(76) Inventors: Blake Martin Langley, Tipton, IN (US); Wendell Wayne Bagley, Noblesville, IN (US)

(21) Appl. No.: 13/083,821

(22) Filed: Apr. 11, 2011

Related U.S. Application Data
(60) Provisional application No. 61/433,599, filed on Jan. 18, 2011.

(51) Int. Cl. G06F 17/30; G06K 19/06

(52) U.S. Cl. 235/380; 707/802; 235/494; 707/E17.045

(57) ABSTRACT

In one embodiment, a method for protecting a child who may become lost is disclosed, comprising the steps of (a) providing an encoded identification device, comprising: a substrate having a surface, and visual coded information disposed upon said surface, wherein said visual coded information encodes a communication address and a unique serial number; (b) entering said unique serial number into a database; (c) entering contact information of said child's parent into said database, said contact information being linked to said unique serial number in said database; (d) decoding said visual coded information to obtain said communication address and said unique serial number; (e) contacting said communication address and transmitting said unique serial number to said communication address; (f) locating said unique serial number within said database; (g) locating said parent contact information in said database that is linked to said unique serial number; and (h) contacting said parent using said parent contact information.

### CROSS-REFERENCE TO RELATED APPLICATION

This application claims the benefit of U.S. Patent Application Ser. No. 61/433,599, filed Jan. 18, 2011, which is hereby incorporated by reference in its entirety.

### TECHNICAL FIELD OF THE INVENTION

The present invention generally relates to object identification systems and, more particularly, to a system and method for locating a lost child's parent/guardian.

### BACKGROUND OF THE INVENTION

The inadvertent separation of a child from its parent or guardian (hereinafter collectively referred to as “parent”), and the subsequent effort to reunite the two, is a problem that has likely existed since the time when humans started to live in groups large enough that every member was not known to every other member of the group. In modern times, children are particularly apt to inadvertently be separated from their parent at places where there are relatively large crowds and things that distract both the child and parent: shopping malls, theme parks, water parks, sporting events, and the like (hereinafter collectively referred to as “venue”).

In most instances, the lost child is located by an official or good Samaritan and is taken to some type of lost child facility. The child who is young enough to wander away from its parent is usually also too young to be able to give the authorities any information useful in locating or contacting the parent. The result is that, even though likely all such children are eventually reunited with their parent, there may be a considerable delay before this is able to be effectuated, causing unwanted psychological trauma for both the child and parent.

In the past, solutions to this problem normally involved a) body harnesses to physically tie the child to the parent, which are cumbersome and looked upon my many parents as a type of “dog leash” that they do not want to subject their child to, or b) all manner of identification tags and bracelets which provided information about the child, such as its name, its parent's name and telephone number, which nearly all parents believe are dangerous because such information is welcomed by potential kidnappers and should not be provided to them.

The present invention is therefore directed toward solving these problems.

### SUMMARY OF THE INVENTION

In one embodiment, an encoded identification device is disclosed, comprising a substrate having a surface, and visual coded information disposed upon said surface, wherein said visual coded information encodes a communication address and a unique serial number.

In another embodiment, an encoded identification device is disclosed, comprising a substrate having a surface, a communication address disposed upon said surface, and visual coded information disposed upon said surface, wherein said visual coded information encodes at least a unique serial number.

In yet another embodiment, a method for protecting a child who may become lost is disclosed, comprising the steps of (a) providing an encoded identification device, comprising: a substrate having a surface, and visual coded information disposed upon said surface, wherein said visual coded information encodes a communication address and a unique serial number; (b) entering said unique serial number into a database; (c) entering contact information of said child's parent into said database, said contact information being linked to said unique serial number in said database; (d) decoding said visual coded information to obtain said communication address and said unique serial number; (e) contacting said communication address and transmitting said unique serial number to said communication address; (f) locating said unique serial number within said database; (g) locating said parent contact information in said database that is linked to said unique serial number; and (h) contacting said parent using said parent contact information.

### BRIEF DESCRIPTION OF THE DRAWINGS

FIG. 1 is a schematic perspective view of a first embodiment encoded identification device of the present disclosure.

FIG. 2 is a schematic plan view of a plurality of the first embodiment encoded identification devices of FIG. 1.

FIG. 3 is a schematic process flow diagram of a first embodiment method for assigning an encoded identification device to a child.

FIG. 4 is a schematic process flow diagram of a first embodiment method for locating the parent of a lost child using an encoded identification device.

FIG. 5 is a schematic plan view of a second embodiment encoded identification device of the present disclosure.

### DETAILED DESCRIPTION OF THE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, and alterations and modifications in the illustrated devices and methods, and further applications of the principles of the invention as illustrated therein are herein contemplated as would normally occur to one skilled in the art to which the invention relates.

In one embodiment, the systems and methods of the present disclosure utilize a encoded identification device carried by the child that contains encoded information. The encoded identification device can take any convenient form, such as a bracelet to be worn by the child. In other embodiments, the encoded identification device can take the form of a sticker applied to the child or its clothing, a necklace, an ankle bracelet, a pin, a temporary tattoo, or the like.

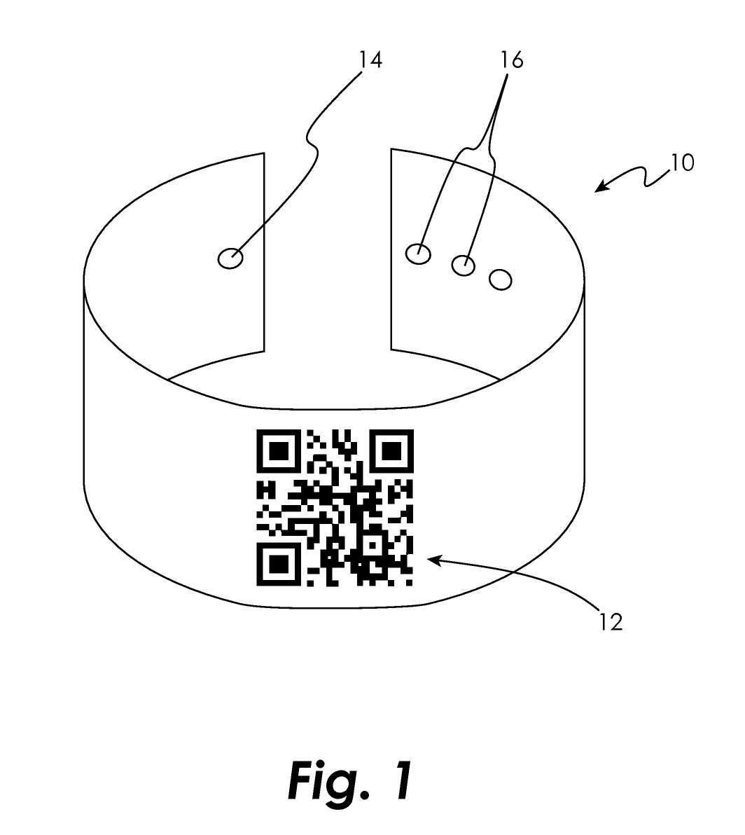

FIG. 1 schematically illustrates a first embodiment encoded identification device in the form of a bracelet and indicated generally at 10. The encoded identification device 10 comprises a substrate and includes visual coded information 12 formed upon a surface thereof. In the illustrated embodiment of FIG. 1, the visual coded information 12 comprises a two dimensional barcode, such as a QR code, SPARQCode, EZcode, or JAGTAG, to name just a few non-limiting examples. Those skilled in the art will recognize that there exist a great number of two dimensional barcode formats in existence, with many more almost certainly to be developed, and it is not critical to the presently disclosed embodiments which particular format is used. In other embodiments, the visual coded information 12 may comprise a one dimensional barcode or any other type of coded message that can be visually detected.

The visual coded information 12 contains a communication address (such as, for example, a telephone number, a website address, etc.). The visual coded information 12 is designed to be read and decoded by an optical scanner and associated software. For example, suitable optical scanners may comprise purpose-built devices that are operative to scan the visual coded information 12, provide the scanned data to a computing device, and decode the scanned data using software running on the computing device. In other embodiments, the optical scanner may comprise the camera built into a mobile telephone or other communication device. For example, ScanLife (54 West 39th Street, 4th Floor, NYC, NY, 10018 USA), NeoReader (Two Concourse Parkway, Suite 500, Atlanta, Ga., USA) and SPARQCode (Seattle, Wash. USA; www.sparqcode.com) all provide reader software that may be loaded onto a mobile telephone to use the mobile telephone's internal camera as the optical scanner. When using such systems, when the mobile telephone is used to take a picture of the two dimensional barcode, software resident on the mobile telephone decodes the barcode from the digital picture data. This decoded information may be used to automatically dial a telephone number encoded within the barcode or launch a web browser to display a website encoded within the barcode. Alternatively, a mobile computer such as a Motorola MC5590 (available from Motorola Solutions, Inc., 1303 East Algonquin Road, Schaumburg, Ill. 60196 USA) may be used as the optical scanner and will run the software that is used to decode the visual coded information 12 and communicate with the lost child center.

In the first embodiment encoded identification device 10, the visual coded information 12 includes both a telephone number to be called, as well as a unique serial number of the encoded identification device 10. As is described in greater detail hereinbelow, the unique serial number (or other unique alphanumeric code, collectively herein referred to as “serial number”) may be associated with contact information for the parent of the child who is wearing the encoded identification device 10. The encoded identification device 10 further includes means to securely attach the encoded identification device 10 to the child, such as a protrusion 14 that mates with one of a plurality of holes 16, adhesive, buckles or any other type of coupling that would occur to one of ordinary skill in the art, the particular type of attachment used not being critical to the presently disclosed embodiments. As discussed above, the encoded identification device 10 could also take the form of a sticker applied to the child or its clothing, a necklace, an ankle bracelet, a pin, a temporary tattoo, or the like. The encoded identification device 10 may further be constructed as a continuous band of elastic material that may be stretched to place it on the child's wrist or ankle.

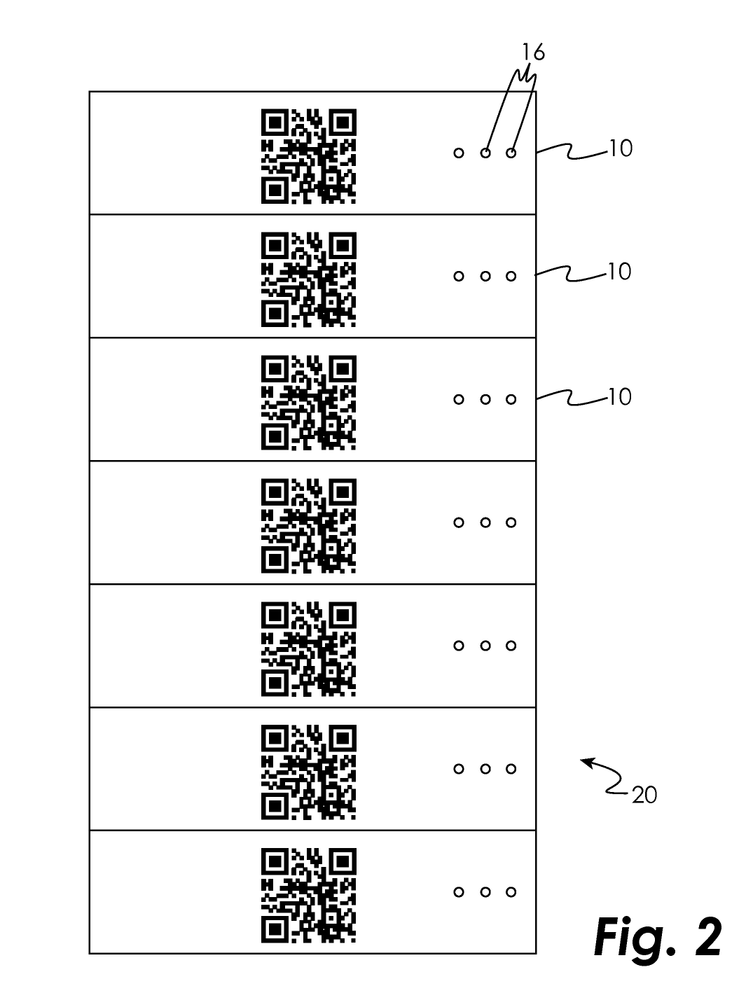

As shown in FIG. 2, the encoded identification devices 10 may be provided to an institutional user (such as the operator of a venue) in bulk form. As one non-limiting example, the encoded identification devices 10 may be provided in pre-printed sheets 20 that contain a number of encoded identification devices 10, as shown in FIG. 2. The encoded identification devices 10 may be separated from one another by means of perforations 22, for example. In other embodiments, the encoded identification devices 10 may be separated from the sheet 20 by cutting, by peeling the encoded identification device 10 off of a backing layer, or by any other convenient means. By providing the encoded identification devices 10 in a bulk manner, each encoded identification device 10 may contain a visual coded information 12 containing a unique (e.g., sequential) serial number as well as the telephone number to be called. Alternatively, the encoded identification devices 10 may be supplied individually, or they may be printed by the end user as needed. In one embodiment, the encoded identification devices to may be printed using a Zebra 110xi4 300 dpi 4 inch printer (available from Zebra Technologies Corporation, 475 Half Day Road, Suite 500, Lincolnshire, Ill. 60069 USA) using NiceLabel Pro label design software (available from Niceware International, LLC, 200 South Executive Drive, Suite 200, Brookfield, Wis. 53005).

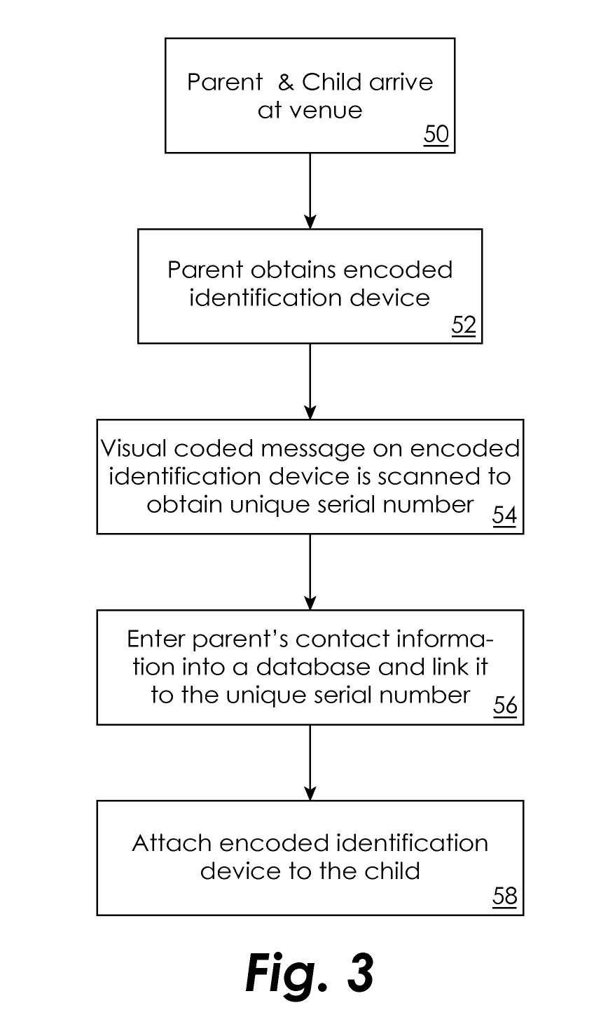

As shown in FIG. 3, one embodiment method of the presently disclosed embodiments begins at step 50, where a parent and child arrive at a venue. At step 52, the parent obtains an encoded identification device 10 for the child. The encoded identification device 10 has a visual coded information 12 thereon containing a unique serial number and the telephone number of the venue's lost child center, security office, or the like. The visual coded information 12 is scanned at step 54 in order to ascertain the unique serial number of the encoded identification device 10. At step 56, the parent's contact information, such a the parent's mobile telephone number, is entered into a database and linked to the unique serial number of the encoded identification device 10. As one non-limiting example, the visual coded information 12 may be scanned under the control of appropriate software, whereupon the unique serial number is entered into a computerized database and the parent's contact information is also entered into the database and linked to the unique serial number. The encoded identification device 10 is attached to the child at step 58. Thereafter, the parent and child are free to explore the venue, knowing that the child is carrying means to quickly and easily contact the parent if the child becomes separated from the parent.

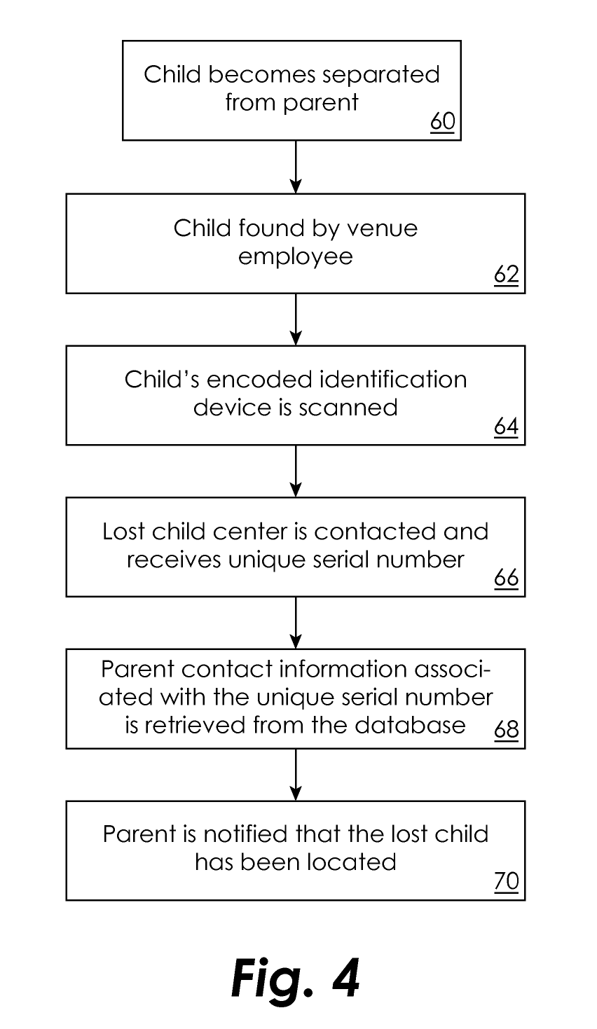

FIG. 4 schematically illustrates a method for reuniting a child wearing an encoded identification device 10 once the child has become separated from his or her parent. At step 60, the child becomes separated from the parent, but at step 62 the child is found by a venue employee or a good Samaritan. The visual coded information 12 on the child's encoded identification device 10 is scanned at step 64, revealing the unique serial number and the telephone number of the venue's lost child center. In some embodiments, the lost child center is a remote service provider who will receive the call and initiate communications with the venue employees (e.g., the venue security office) and the parent. In other embodiments, the lost child center is located within the venue. The lost child center is contacted by telephone at step 66 and the unique serial number scanned from the encoded identification device 10 is given to the lost child center employee.

In some embodiments, the encoded identification device 10 is scanned with a scanner by a venue employee, and the visual coded information 12 is displayed to the venue employee. The venue employee will then place a call to the displayed telephone number of the lost child center and verbally provide the displayed unique serial number to the lost child center over the telephone. In other embodiments, the scanner is operatively coupled to control software that receives the telephone number and unique serial number in the visual coded information 12 and automatically places a telephone call to the received telephone number and thereafter automatically transmits the unique serial number to the lost child center. In some embodiments, the control software is resident on a mobile telephone and the scanner is a camera that is integral to the mobile telephone. In some embodiments, the control software is resident on a mobile computer with an integral scanner. In some embodiments, the visual coded information 12 includes an internet address to which the control software connects instead of placing a telephone call. Once connected to the appropriate web site, the control software may upload the unique serial number in order to initiate contact with the parent. In some embodiments, a good Samaritan who finds a lost child may have to locate a venue employee in order to scan the encoded identification device 10. In other embodiments, the good Samaritan is a guest of the venue (such as another parent) who has been provided with a software application downloaded to the good Samaritan's mobile telephone, allowing the good Samaritan the ability to scan the encoded identification device 10 and initiate the reunification process. In embodiments where the scanning and communicating is performed by a mobile telephone or computer that is equipped with global positioning system (GPS) functionality, the contact with the lost child center can include transmission of the current location of the child in addition to the unique serial number scanned from the encoded identification device 10.

At step 68, the lost child center reviews the database in order to find the parent contact information linked to the unique serial number that has been retrieved from the lost child's encoded identification device 10. The parent is contacted at step 70 and notified that their child has been located and arrangements are made to reunite the parent and child. In some embodiments, the lost child center employs automated equipment to receive the unique serial number and to contact the parent, playing a prerecorded message to the parent advising them as to where they may be reunited with the lost child.

By using the encoded identification device 10 of the presently disclosed embodiments, reunification of the parent and lost child can be easily and safely effectuated, with no worries that potential kidnappers will gain access to contact information of the parent, since the visual coded information 12 on the encoded identification device 10 does not contain the parent's contact information—this information is only held in the database maintained by the lost child center. Therefore, even if the kidnapper possessed a scanner to decode the visual coded information 12 on the encoded identification device 10, the only information that would be revealed to him would be the unique serial number and the telephone number (or other contact address) of the lost child center.

Many business models may be built around the encoded identification device 10. Because of the very low expense of producing the encoded identification device 10 in bulk and the software that can be executed by a mobile telephone or computer, a venue can implement the presently disclosed embodiments with very low start-up costs. The venue may decide to recoup the cost of the encoded identification devices 10 in the price of admission to the venue, or the venue may charge extra for the encoded identification device 10 as a value-added service. Some venues may decide to sell encoded identification devices 10 that are operative for an extended period of time, such as one year or even for the lifetime of the child, so that the encoded identification device 10 may be retained by the parent and used every time the parent and child visit the venue. In some embodiments, the parent may be able to purchase (or otherwise obtain) the encoded identification device 10 in advance of visiting the venue, such as by ordering the encoded identification device 10 through a web site operated by the venue or by a service provider contracted by the venue. The parent's contact information may be entered through the web site so that the encoded identification device 10 will be operational when the parent and child arrive at the venue. If an independent third party service provider is operating the encoded identification device 10 system, then a single encoded identification device 10 may be operative at multiple venues with which the third party service provider contracts with, requiring only a single encoded identification device 10 to be obtained for the child to be protected at multiple venues.

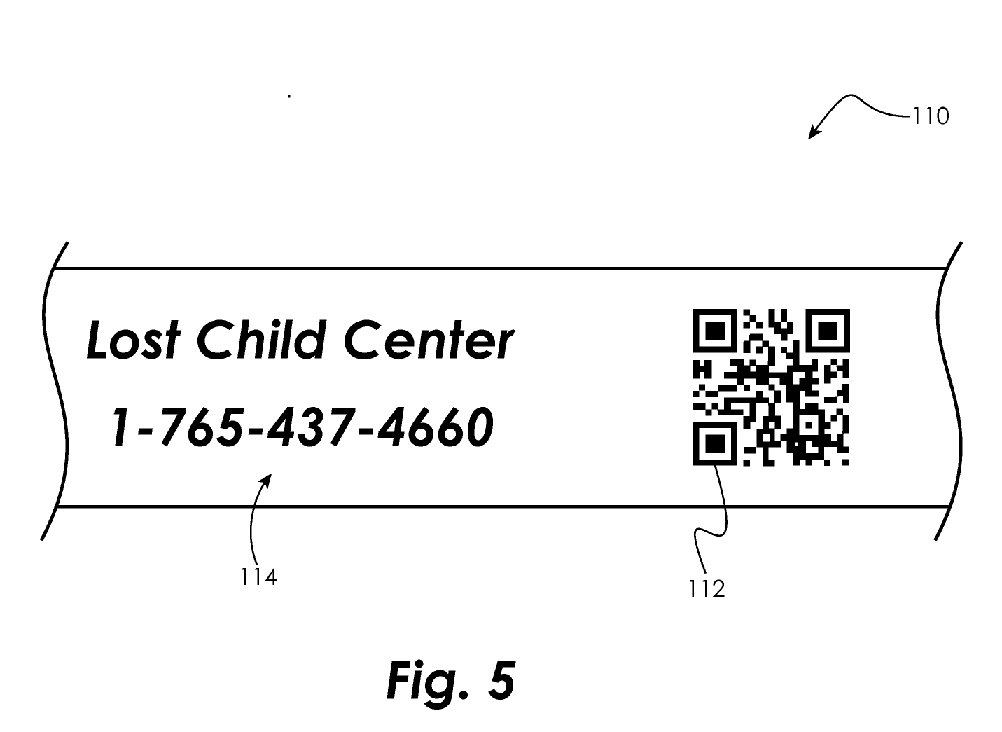

FIG. 5 illustrates an alternate embodiment encoded identification device, indicated generally at 110. Encoded identification device 110 includes visual coded information 112 that contains a unique serial number, and optionally the telephone number of the lost child center. Encoded identification device 110 also includes a non-encoded display 114 of the telephone number of the lost child center. The encoded identification device 110 may therefore be used to provide the telephone number of the lost child center to a good Samaritan who locates the lost child but has no way to scan the visual coded information. In all other respects, the encoded identification device 110 may be used in a manner analogous to the encoded identification device 10 discussed hereinabove. It will be appreciated that the encoded identification device 110 may also be useful to protect a child even if not at a particular venue, because the telephone call to the number listed on the encoded identification device 110 (e.g. to a third party security company) can initiate the dispatching of law enforcement personnel to retrieve the lost child from the good Samaritan, whereupon the visual coded information 112 may be scanned to obtain the unique serial number, which may further be used to obtain the parent's contact information. In this manner, the encoded identification device 110 may be worn on children at all times in order to provide such protection in the event that they become lost.

It will be appreciated by those skilled in the art that the various embodiments disclosed herein are also applicable to incapacitated adults in addition to children. Therefore, as used herein and in the appended claims, the word “child” also encompasses incapacitated adults, and the word “parent” also encompasses parents and/or caretakers of such incapacitated adults.

It will also be appreciated by those skilled in the art that the various embodiments disclosed herein are also applicable to pets in addition to children. Therefore, as used herein and in the appended claims, the word “child” also encompasses pet animals, and the word “parent” also encompasses owners and/or caretakers of such pet animals.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed:

1. An encoded identification device, comprising:
a substrate having a surface; and
visual coded information disposed upon said surface;
wherein said visual coded information encodes a communication address and a unique serial number.

2. The encoded identification device of claim 1, wherein said substrate is selected from the group consisting of: a bracelet, a sticker, a necklace, an ankle bracelet, a pin, and a temporary tattoo.

3. The encoded identification device of claim 1, wherein said substrate comprises plastic.

4. The encoded identification device of claim 1, wherein said substrate comprises an elastic material.

5. The encoded identification device of claim 1, wherein said visual coded information is printed upon said surface.

6. The encoded identification device of claim 1, wherein said visual coded information comprises a two-dimensional barcode.

7. The encoded identification device of claim 1, wherein said communication address comprises a telephone number.

8. The encoded identification device of claim 1, wherein said communication address comprises a website address.

9. A method for protecting a child who may become lost, comprising the steps of:
(a) providing an encoded identification device, comprising:
a substrate having a surface; and
visual coded information disposed upon said surface;
wherein said visual coded information encodes a communication address and a unique serial number;
(b) entering said unique serial number into a database; and
(c) entering contact information of said child's parent into said database, said contact information being linked to said unique serial number in said database.

10. The method of claim 9, further comprising the step of:
(d) scanning said visual coded information; and
(e) decoding said scanned visual coded information to obtain said unique serial number prior to executing step (b).

11. The method of claim 10, wherein step (d) further comprises scanning said visual coded information with a camera associated with a mobile telephone.

12. The method of claim 11, wherein step (e) further comprises decoding said scanned visual coded information using software resident on said mobile telephone to obtain said unique serial number prior to executing step (b).

13. The method of claim 9, wherein said unique serial number comprises alphanumeric digits.

14. The method of claim 9, wherein said contact information comprises a telephone number of said parent.

15. The method of claim 9, further comprising the steps of:
(d) decoding said visual coded information to obtain said communication address and said unique serial number;
(e) contacting said communication address and transmitting said unique serial number to said communication address;
(f) locating said unique serial number within said database;
(g) locating said parent contact information in said database that is linked to said unique serial number; and
(h) contacting said parent using said parent contact information.

16. The method of claim 15, wherein step (d) further comprises:
(d.1) scanning said visual coded information; and
(d.2) decoding said scanned visual coded information to obtain said unique serial number.

17. The method of claim 15, wherein step (e) comprises calling a telephone number.

18. An encoded identification device, comprising:
a substrate having a surface;
a communication address disposed upon said surface; and
visual coded information disposed upon said surface;
wherein said visual coded information encodes at least a unique serial number.

19. The encoded identification device of claim 18, wherein said substrate is selected from the group consisting of: a bracelet, a sticker, a necklace, an ankle bracelet, a pin, and a temporary tattoo.

20. The encoded identification device of claim 18, wherein said substrate comprises plastic.

21. The encoded identification device of claim 18, wherein said substrate comprises an elastic material.

22. The encoded identification device of claim 18, wherein said visual coded information is printed upon said surface.

23. The encoded identification device of claim 18, wherein said visual coded information comprises a two-dimensional barcode.

24. The encoded identification device of claim 18, wherein said communication address comprises a telephone number.

25. The encoded identification device of claim 18, wherein said communication address comprises a website address.
